(19) United States
(12) Patent Application Publication
(10) Pub. No.: US 2010/0235856 A1
(43) Pub. Date: Sep. 16, 2010

(54) METHOD, SYSTEM, AND DEVICE FOR REALIZING INTERNET PROTOCOL TELEVISION SERVICE

(76) Inventor: Hui Huang, Shenzhen (CN)

Correspondence Address: Huawei/BHGL, P.O. Box 10395, Chicago, IL, 60610, US

(21) Appl. No.: 12/787,130

(22) Filed: May 25, 2010

Related U.S. Application Data
(63) Continuation of application No. PCT/CN2008/072464, filed on Sep. 23, 2008.

(30) Foreign Application Priority Data
Dec. 13, 2007 (CN) 200710125055.5

(51) Int. Cl. H04N 7/173

(52) U.S. Cl. 725/25; 725/110; 725/93

(57) ABSTRACT

A method, system, and device for realizing an Internet Protocol television (IPTV) service are provided. The method includes the following steps. A message sent by a user terminal in a protocol format compatible with an IP multimedia subsystem (IMS) is received. The message in the protocol format compatible with the IMS is converted to a message in a protocol format compatible with an IPTV system. The message in the converted protocol format compatible with the IPTV system is transmitted to a corresponding entity in the IPTV system according to the content of the message. A conversion device is added between the conventional IPTV system and the IMS, so as to solve the problem in the prior art that a thorough and overall modification must be performed on the existing network system, thereby realizing interworking between the conventional IPTV system and the IMS, and achieving smooth upgrading of the IPTV system in the IMS network.

### CROSS-REFERENCE TO RELATED APPLICATIONS

This application is a continuation of International Application No. PCT/CN2008/072464, filed on Sep. 23, 2008, which claims priority to Chinese Patent Application No. 200710125055.5, filed on Dec. 13, 2007, both of which are hereby incorporated by reference in their entireties.

### FIELD OF THE TECHNOLOGY

The present invention relates to the field of communication technology, and more particularly to a method, system, and device for realizing an Internet Protocol television (IPTV) service.

### BACKGROUND OF THE INVENTION

Internet Protocol television (IPTV) is an IP-based TV broadcasting service. Based on the IP technology, IPTV provides interactive services, mainly streaming media services, for users through a manageable network. The interactive services include basic services like TV live, video on demand (VOD), and pause live TV (PLTV), and also include triple play services of communication, data, and video developed based on the basic services. An IPTV system has the functions of achieving network transparency, supporting fixed and mobile networks at the same time, having an open service integration environment, having a standardized service capability of allowing new services to be conveniently added and a plurality of services to be converged, having a uniform user and service management and accounting system, and ensuring end-to-end quality of service (QoS).

An IP multimedia subsystem (IMS) provides a method for solving the above problem. The IMS is proposed in Release 5 version standard by the 3rd Generation Partnership Project (3GPP). Based on a Session Initiation Protocol (SIP) system, the IMS creates, manages, and terminates various types of multimedia services by using an SIP call control mechanism. Various types of clients may set up end-to-end IP communication through the IMS, and obtain the desired QoS. In addition to the session management, the IMS also finishes necessary functions for providing the services. For example, the functions may be registration, security, accounting, bearer control, and roaming. The IMS provides a basis for service convergence, and supports voice, data, and multimedia services and new applications based on the IP technology.

Therefore, the IPTV service is developed based on the IMS network architecture, which has already become a common understanding among many communication equipment suppliers and operators, and is a developing trend of the service.

However, recently the deployment of the IPTV system in the IMS does not have a uniform standard, and different manufacturers have different ideas. Usually, a thorough modification is performed, that is, the existing service control and media session control mechanisms of the conventional IPTV system are discarded, and an SIP-based session control method in the IMS is completely adopted.

In the existing IPTV system based on the IMS service control, a call session control function (CSCF) directly performs service control on an IPTV application server (IPTV AS) through SIP message interaction, in which the service control includes user authentication, service subscription, authority control when the service is used, and the like. The above-mentioned controls do not have a uniform specification in the conventional IPTV system, and basically each manufacturer adopts a private protocol, for example, a private protocol based on a Hypertext Transfer Protocol (HTTP). The service control is realized by the IMS-CSCF in the IMS network architecture. The IPTV AS performs information interaction with the CSCF through the standard SIP. In order to support the IMS architecture, in the existing method, a private service control protocol in the conventional IPTV system is replaced by a standard control protocol over SIP.

The IMS-CSCF directly performs media session control with a content distribution and storage server through SIP message interaction, in which the media session control includes media server resource allocation when the media content is distributed, session setup, fast forward, fast reverse, location control, session teardown, and other procedures. For the above-mentioned controls, the conventional IPTV system performs media session control by adopting a Real Time Streaming Protocol (RTSP) specified by a Request for Comments (RFC) 2326 standard. The message control of the media session control is based on SIP in the IMS network architecture. In order to support the IMS architecture, in the existing method, RTSP is replaced by the SIP.

Known IPTV systems based on conventional session control methods are deployed throughout existing network, the large number of deployed IPTV systems may impact and effect the smooth upgrading and interworking of the existing network systems as well as increasing the difficulty, and/or increase difficulty of modifying or implementing modifications of the existing systems.

### SUMMARY

Accordingly, the disclosed embodiments provide technical solutions to solve the impacts and difficulties resulting from the thorough and overall modification performed on the existing network system when the Internet Protocol television (IPTV) service based on the IP multimedia subsystem (IMS) service control is realized in the prior art.

In an embodiment, the disclosure provide a system for realizing an IPTV service, which includes an IPTV application server (IPTV AS) and a content distribution and storage server, and further includes a conversion device.

The conversion device is adapted to receive a message sent by a user terminal in a protocol format based on a multimedia subsystem, convert the message between a message in the protocol format based on the multimedia subsystem and a message in a protocol format compatible with an IPTV system, and transmit the converted message in the protocol format compatible with the IPTV system to the IPTV AS and/or the content distribution and storage server according to the content of the message.

In an embodiment, the disclosure further provide a conversion device, which is applied to an IPTV service based on multimedia subsystem service control, and includes a receiving unit, a conversion unit, and a request processing unit.

The receiving unit is configured to receive a message sent by a user terminal in a protocol format based on a multimedia subsystem.

The conversion unit is configured to convert the message between a message in the protocol format compatible with the multimedia subsystem and a message in a protocol format based on an IPTV system.

The request processing unit is adapted to transmit the converted message in the protocol format compatible with the IPTV system to a corresponding entity in the IPTV system according to the content of the message.

In an embodiment, the disclosure further provides a method for realizing an IPTV service, which includes the following steps.

A message sent by a user terminal in a protocol format compatible with a multimedia subsystem is received.

The message is converted between a message in the protocol format compatible with the multimedia subsystem and a message in a protocol format compatible with an IPTV system.

The converted message in the protocol format compatible with the IPTV system is transmitted to a corresponding entity in the IPTV system according to the content of the message.

It can be seen from the above technical solutions that, a conversion device is added between the conventional IPTV system and the multimedia subsystem, so as to solve the problem in the prior art that a thorough and overall modification must be performed on the existing network system, thereby realizing interworking between the conventional IPTV system and the multimedia subsystem, and achieving smooth upgrading of the IPTV system in the multimedia subsystem network.

### BRIEF DESCRIPTION OF THE DRAWINGS

To illustrate the technical solutions according to the disclosed embodiments, the accompanying drawings required for describing the embodiments or the prior art are introduced below briefly. The accompanying drawings and the following descriptions merely show some of the embodiments of the present invention, and persons of ordinary skill in the art can obtain other drawings according to the accompanying drawings without making creative efforts.

FIG. 1 is a schematic structural view of a system for realizing an IPTV service according to an embodiment of the present invention;

FIG. 2 is a flow chart of a method for realizing account opening, registration, and subscription of the IPTV service based on the system in FIG. 1 according to an embodiment of the present invention;

FIG. 3 is a flow chart of a method for realizing an on-demand IPTV service based on the system in FIG. 1 according to an embodiment of the present invention; and

FIG. 4 is a flow chart of a method for realizing a live IPTV service based on the system in FIG. 1 according to an embodiment of the present invention.

### DETAILED DESCRIPTION OF THE EMBODIMENTS

The technical solution according to some exemplary embodiments of the present invention will be clearly and fully described below with reference to the accompanying drawings. It is obvious that the embodiments to be described are a part rather than all of the embodiments of the present invention. All other embodiments derived by those skilled in the art based on the embodiments of the present invention without carrying out creative activities should fall within the scope of the present invention.

In an embodiment, the disclosure provides a method for realizing an IPTV service, which includes the following steps. A message sent by a user terminal through a CSCF in a protocol format compatible with an IMS domain is received, in which the message may be a request message or other messages. The message in the protocol format based on the IMS domain is converted to a message in a protocol format based on an IPTV system. The converted message in the protocol format compatible with the IPTV system is transmitted to a corresponding entity in the IPTV system according to the content of the message. Therefore, the problem in the conventional art that a thorough and overall modification must be performed on the existing network system is eliminated, thereby realizing interworking between the conventional IPTV system and the IMS, and achieving smooth upgrading of the IPTV system in the IMS network.

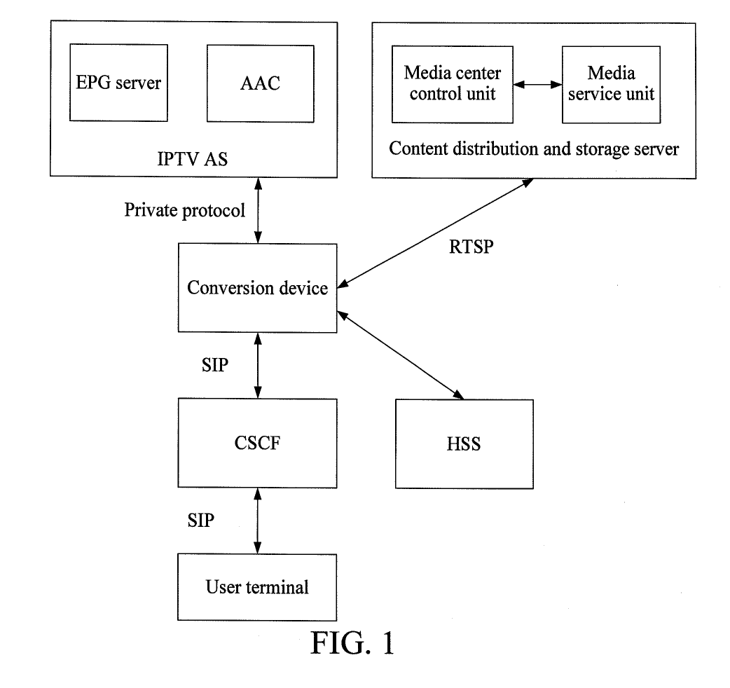

In order to realize the above method, in an embodiment, the disclosure provides an IPTV system supporting IMS service control. FIG. 1 is a schematic structural view of the system according to the embodiment of the disclosure. The system includes an IPTV AS, a content distribution and storage server, a conversion device, an IMS-CSCF, a home subscriber server (HSS), and a user terminal. For example, the user terminal may be a set-top box or a cell phone.

The IPTV AS is an AS in the IPTV system, and provides service browsing, selection, subscription, and other functions for the user. The IPTV AS is mainly composed of an electronic program guide (EPG) server and an authentication and authorization center (AAC). The EPG provides service browsing, selection, and other service navigation functions. The AAC saves service data including user subscription information about the service, receives a service request from the user, and performs a service access authentication on the user.

The content distribution and storage server is adapted to transmit the content to the user, and further has a content storage function for on-demand and recorded programs. A large-scale system is usually a distribution network composed of a plurality of nodes (media service units), and the dispatching among the nodes is coordinated and controlled by a media center control unit. The content distribution has two main modes. For a live program, the content is transmitted in a multicast mode. For an on-demand program, the content is transmitted in a unicast mode and in response to fast forward, fast reverse, pause, and other requests from the user.

The conversion device mainly includes a receiving unit, an information acquisition unit, a conversion unit, and a request processing unit.

The receiving unit is adapted to receive registration, subscription, content request, and other request messages sent through the CSCF.

The information acquisition unit is adapted to request user service data information about the user when opening an account in two different domains (i.e. the IPTV domain and the IMS domain) and association relations between the information in the two domains from the HSS after receiving a registration request from the user, and save the obtained user service data information and the association relations thereof. The user service data includes a user identifier (ID).

The conversion unit is adapted to convert the IMS user ID (for example, SIP URI) obtained by the information acquisition unit to a conventional IPTV user ID; convert protocol format between a protocol format based on the IMS (for example, the SIP) and a private protocol based on the IPTV system during service control, in which the conversion may be applied to user subscription, subscription canceling, session request, session control, and other procedures; and convert the protocol format based on the IMS (for example, the SIP) to an RTSP based on the IPTV system during media session control, in which the conversion may be applied to media server resource allocation, session setup, fast forward, fast reverse, location control, session teardown, and other procedures when the media content is distributed.

The request processing unit is adapted to transmit the converted request in the protocol format based on the IPTV system to a corresponding entity in the IPTV system, according to a request message based on the IMS sent by the CSCF, and, and further adapted to transmit the converted response message in the protocol format based on the IMS to the CSCF, according to a response message returned by a corresponding entity in the IPTV system. In actual applications, a converted message in the corresponding protocol format based on the IPTV system may be sent to a corresponding entity in the IPTV system according to the specific content of the message sent by the CSCF. For example, the message in a format based on the corresponding protocol may be an HTTP, RTSP, and other private protocols. For example, if the CSCF sends an on-demand content request message, the content request is transmitted to a media control unit and a media server through the converted RTSP based on the IPTV. Optionally, an authentication request is transmitted to the AAC through a converted private protocol based on the IPTV.

An interactive message format between the conversion device and the EPG in the IPTV system or the AAC is based on a converted private protocol in the IPTV system. An exchange protocol between the conversion device and the content distribution and storage server in the IPTV system may be the RTSP in the IPTV system. An interactive protocol between the conversion device and the CSCF in the IMS domain may be a protocol format based on the IMS domain, for example, the SIP.

Optionally, the system further includes an HSS adapted to save the user service data of the user in the IMS domain and the IPTV domain and the association relations between the user service data in the two domains. The conversion device requests the user service data of the user in the two domains and the association relations between the user service data in the two domains from the HSS through an Sh protocol, and saves the obtained user service data and the association relations thereof, in which the user service data includes the user ID and other information. The conversion device is further adapted to convert a user ID between the IMS domain and the IPTV domain. In practice, the user service data of the user in the IMS domain and the IPTV domain and the association relations between the user service data in the two domains may be saved in a business and operation support system (BOSS), and the conversion device directly requests the user service data and the association relations thereof from the BOSS.

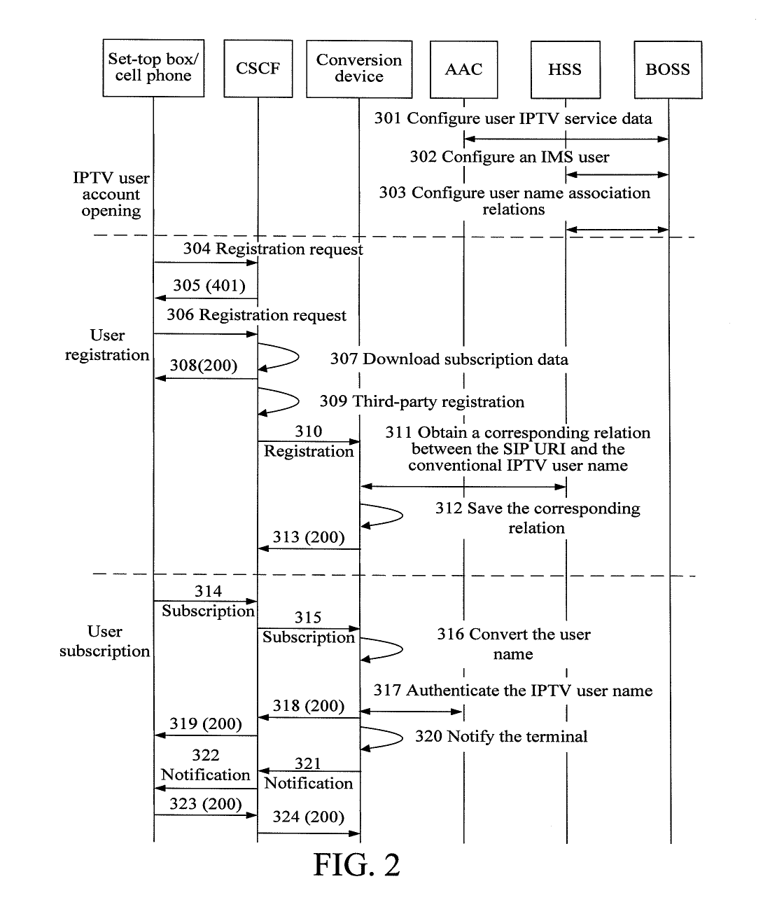

In order to have a further understanding of the embodiment of the disclosure, it is taken as an example for illustration that the system is applied to user account opening, registration, service subscription, on-demand service, live service, and other procedures. FIGS. 2, 3, and 4 are flow charts of the method of the embodiment, and a detailed description is given as follows.

FIG. 2 is a flow chart of user account opening, registration, and service subscription, which includes the following steps.

IPTV user account opening stage:

In step 301, when an IPTV user opens a new account, the BOSS performs an IPTV user service data configuration on the existing IPTV system, and saves the data in the AAC in the IPTV domain.

In step 302, a new account needs to be opened in the IMS domain, and the BOSS performs an IMS user service data configuration on the HSS in the IMS domain.

In step 303, the BOSS associates the user service data information in the two domains through configuration association relations, and synchronizes the user service data information in the two domains to the HSS. It should be noted that, the BOSS may not perform this step, and instead, the conversion device directly obtains the user service data information in the two domains and the association relations thereof from the BOSS.

User Registration Stage:

In steps 304 to 306, the IPTV user initiates a registration request in the IMS network to the CSCF in the IMS domain through a terminal equipment, for example, a set-top box or a cell phone.

In steps 307 to 308, the CSCF downloads subscription data, and returns 200OK after confirming that the user is a valid IMS subscriber.

In steps 309 to 310, the CSCF triggers a third-party registration to the conversion device.

In steps 311 to 313, the conversion device interacts with the HSS via an Sh interface to obtain a corresponding relation between an SIP universal resource identifier (URI) and a conventional IPTV user name, and saves the corresponding relation. That is to say, the conversion device obtains and saves the currently registered IMS user name and the corresponding IPTV user name and password, and returns a response message indicating that the registration is successful to the CSCF.

After the registration is successfully completed, through a subscription-notification mode, service related information is delivered to the terminal in a Notify message, and the service related information includes, for example, an address of the EPG server and an issue number of an EPG channel list. The set-top box may re-determine whether to download and update the EPG channel list or not according to the issue number of the EPG channel list.

User Subscription Stage:

In steps 314 to 315, after the registration of the IPTV user is successfully completed, the terminal (for example, the set-top box or the cell phone) initiates an IPTV information subscription request to the conversion device through the CSCF, in which the request message is an SIP message, and the subscription request message carries the SIP URI and other identifiers of the terminal.

In step 316, the conversion device converts the SIP subscription message to a private message format, for example, an HTTP message, converts the SIP URI in the request message to a private user ID, a password, and other authentication information in the IPTV system, and sends the message to the IPTV AAC.

In steps 317 to 319, the IPTV AAC returns an authentication result to the terminal after authenticating the user. In steps 320 to 324, the conversion device sends a response indicating whether the authentication is successful or not to the terminal through a Notify message.

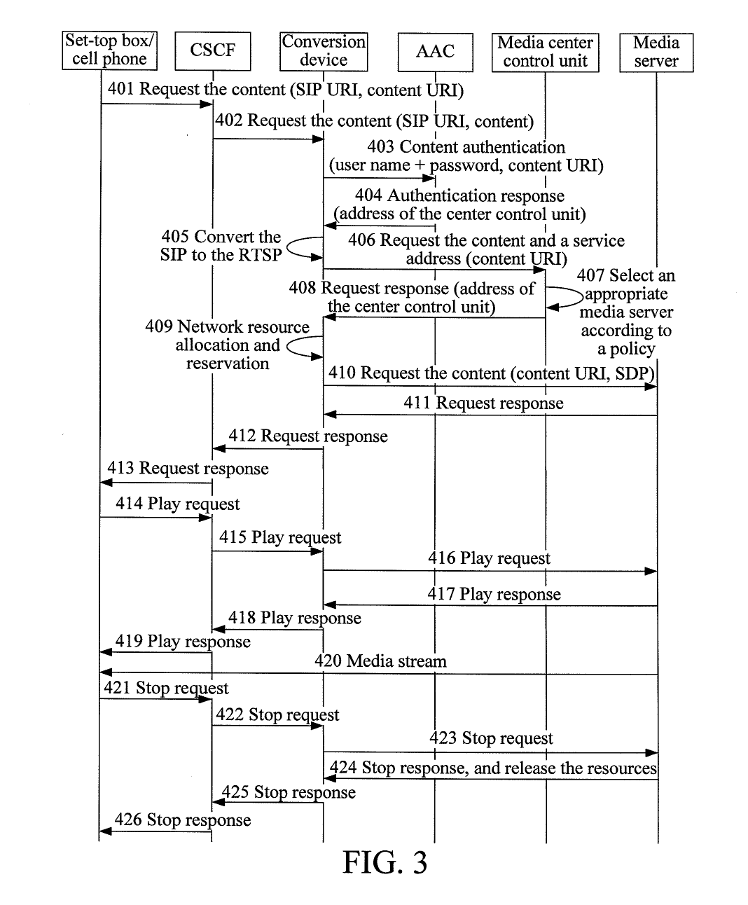

FIG. 3 shows the implementation of an on-demand IPTV service by applying the above system, which includes the following steps.

In steps 401 to 402, when a program is to be consumed through the set-top box or the cell phone terminal, the program is first clicked, and an SIP Invite message carrying a user SIP URI ID and requested content is sent to the conversion device through the CSCF. The requested content includes a uniform resource locator (URL), a session description protocol (SDP) attribute, and other contents.

In step 403, the conversion device converts the SIP message to a private HTTP message of the IPTV system, converts the SIP URI to a private user name of the IPTV system, and uses the information of the private user name, the program URL for service authentication in the IPTV AAC.

In step 404, if the authentication is successful, the AAC returns an authentication response message to the conversion device, in which the message carries address information about the media center control unit.

In steps 405 to 408, according to the address of the media center control unit in the returned message, the conversion device converts the SIP message to an RTSP message, and requests the content and the address URI of the media server from the media center control unit. The media center control unit selects an appropriate media server for providing services according to a corresponding policy, for example, load, health, content, and other status of the media server, and returns an address of the server to the conversion device through a request response.

In step 409, if network resource allocation and reservation are initiated by the CSCF, the network resource allocation and reservation are implemented by a network equipment (for example, a router).

In steps 410 to 413, the conversion device requests the content from the media server in the conventional RTSP message format according to the address of the returned message, and carries media session description information SDP, for example, a coding format and a code rate. After allocating the session resources, the media server returns a response message to the conversion device. The conversion device further converts the RTSP message to the SIP message, and returns the response message to the terminal through the CSCF. Here, the media server successfully sets up a session with the terminal.

In steps 414 to 420, the terminal sends a play request carrying an instruction that indicates a play operation to the conversion device through the CSCF. The conversion device converts the SIP session to an RTSP play command, and sends the command to the media server. The media server returns a play response to the conversion device. The conversion device converts the RTSP message to the SIP message, and returns the play response message to the CSCF. The media server transmits a media stream to the terminal according to the play request.

In steps 421 to 426, when the user needs to stop playing the media, a stop playing request message carrying an instruction that indicates to stop playing is sent to the conversion device through the CSCF. The conversion device converts the SIP session to an RTSP stop playing command, and sends the command to the media server. The media server releases the session resources according to the stop playing request message, and stops transmitting the media stream to the terminal.

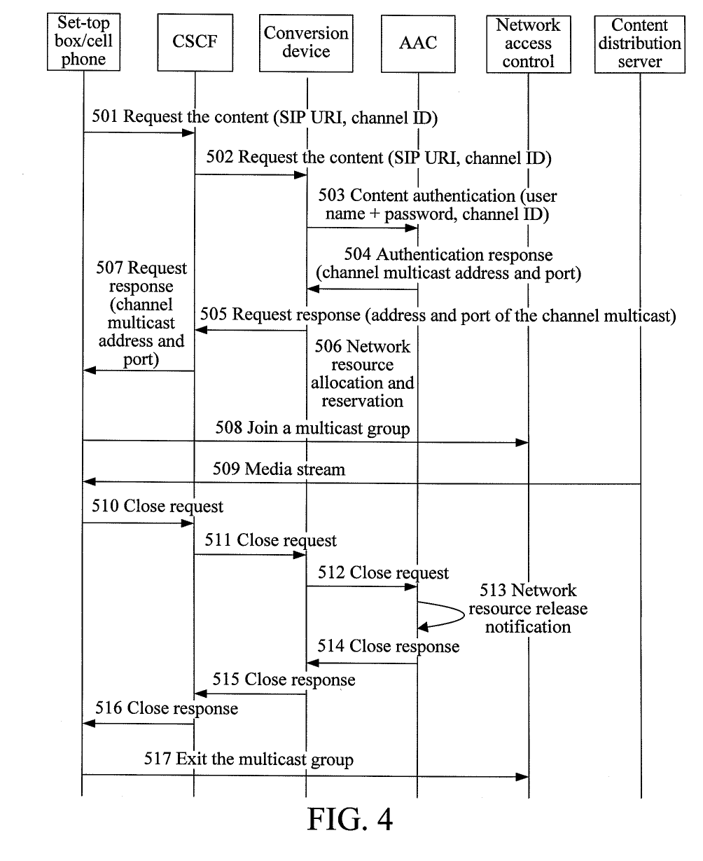

FIG. 4 shows the implementation of a live IPTV service by applying the above system, which includes the following steps.

In steps 501 to 502, when a live program is to be consumed through the set-top box or the cell phone terminal, the program is first clicked, and an SIP Invite message carrying a user SIP URI ID and a channel ID is sent to the conversion device through the CSCF.

In step 503, the conversion device converts the SIP message to a private HTTP message in the IPTV system, converts the SIP URI to a private user name in the IPTV system, and carries the private user name, the password, the channel ID, and other information to the AAC for service authentication.

In steps 504 to 507, if the AAC authentication is successful, the AAC returns an authentication response message carrying a channel multicast parameter (for example, an address or port) to the conversion device, and transmits the authentication response message to the terminal after a message conversion.

In steps 508 to 509, the terminal joins a multicast group through a multicast control protocol. After a successful joining, the terminal receives the media content transmitted from a content distribution server.

In steps 510 to 516, when the channel needs to be closed, the terminal sends a close request to the conversion device through the CSCF. The conversion device converts the SIP request to an HTTP message, and transmits the HTTP message to the AAC. The AAC notifies a related unit to release the session resources and returns a close response.

It should be noted that, for the response message in this embodiment, the protocol based on the IPTV system needs to be converted to the SIP based on the IMS by the conversion device, and then the message is transmitted to the terminal through the CSCF.

In step 517, the terminal exits the multicast group according to the received close response.

It should be noted that, in order to improve the live channel access efficiency, the channel access authorization may be performed in batches, for example, the user is authenticated after registration, and a list of all the channels to which the user has access authority is delivered to the terminal. In this manner, the authorization does not need to be performed each time the channel is switched. For example, after the registration in steps 311 to 313 in the above embodiment is completed, the channel list to which the user has access authority is transmitted to the terminal through the Notify message.

It can be seen from the above description of the embodiment that, a conversion device is added between the conventional IPTV system and the IMS, so as to solve the problem in the prior art that a thorough and overall modification must be performed on the existing network system, thereby realizing interworking between the conventional IPTV system and the IMS, and achieving smooth upgrading of the IPTV system in the IMS network.

Those of ordinary skill in the art should understand that that all or a part of processes in the method according to the embodiments may be implemented by a computer program instructing relevant hardware. The program may be stored in a computer readable storage medium. When the program is executed, the processes of the method according to the embodiments of the disclosure are performed. The storage medium may be a magnetic disk, an optical disk, a read-only memory (ROM), or a random access memory (RAM).

It will be apparent to those skilled in the art that various modifications and variations can be made to the present invention without departing from the scope or spirit of the invention. In view of the foregoing, it is intended that the present invention cover modifications and variations of this invention provided they fall within the scope of the following claims and their equivalents.

What is claimed is:

1. A system for managing an Internet Protocol television (IPTV) service comprising an IPTV application server, and a content distribution and storage server, wherein the system further comprises:
a conversion device configured to:
receive a message sent by a user terminal in a protocol format compatible with an IP multimedia subsystem (IMS),
convert the messages between a message in the protocol format compatible with IMS and a message in a protocol format compatible with an IPTV system, and
transmit the converted message in the protocol format compatible with the IPTV system to one of the IPTV application server and the content distribution and storage server according to a content of the message.

2. The system for realizing an IPTV service of claim 1, wherein the system further comprises:
a home subscriber server configured to store a user service data of the user in the IMS and the IPTV system and an association relations between the user service data in the two domains, wherein the user service data comprises a user identification;
the conversion device further configured to acquire the user service data of the user in the two domains and the association relations between the user service data in the two domains from the home subscriber server, store the user service data and the association relations, and convert the user identification between the acquired user identification in the IMS and a user identification in the IPTV system.

3. The system for realizing an IPTV service of claim 1, wherein the system further comprises:
a business and operation support system configured to store a user service data of the user in the IMS and the IPTV system and an association relations between the user service data in the two domains, wherein the user service data comprises a user identification;
the conversion device further configured to acquire the user service data of the user in the two domains and an association relation between the user service data in the two domains from the business and operation support system, store the user service data and the association relations, and convert the acquired user identification in the IMS to a user identification in the IPTV domain.

4. The system for realizing an IPTV service claim 3, wherein the conversion device is further configured to perform one of the following conversions:
convert the message in the Session Initiation Protocol format compatible with the IMS to a message in the private protocol format compatible with the IPTV system during a service control process; and
convert the message in the Session Initiation Protocol format compatible with the IMS to a message in the Real Time Streaming Protocol format compatible with the IPTV system during a media session control process.

5. A conversion device, which is applied to an Internet Protocol television (IPTV) service based on IMS service control system, wherein the conversion device comprises:
a receiving unit configured to receive a message in a protocol format compatible with an IP multimedia subsystem (IMS) sent by a user terminal;
a conversion unit configured to convert the message between a message in the protocol format compatible with IMS and a message in a protocol format compatible with an IPTV system; and
a request processing unit configured to transmit the converted message in the protocol format compatible with the IPTV system to a corresponding entity in the IPTV system according to the content of the message.

6. The conversion device of claim 5, wherein the conversion device further comprises:
an information acquisition unit configured to acquire and store a user service data of the user in the IMS and the IPTV system and an association relations between the user service data in the two domains, wherein the user service data comprises a user identification; and
the conversion unit, further adapted to convert the user identification between the user identification in the user service data in the IMS and a user identification in the user service data in the IPTV system.

7. The conversion device of claim 6, wherein the request processing unit is further adapted to transmit a converted response message returned from the corresponding entity in the IPTV system in the protocol format compatible with IMS to the user terminal.

8. The conversion device of claim 6, wherein the conversion unit is configured to perform one of the following conversions:
convert the message in the Session Initiation Protocol format compatible with the IMS to a message in the private protocol format compatible with the IPTV system during a service control process; and
convert the message in Session Initiation Protocol format based on the IMS to a message in the Real Time Streaming Protocol format compatible with the IPTV system during a media session control process.

9. A method for realizing an Internet Protocol television (IPTV) service, comprising:
receiving a message sent by a user terminal in a protocol format compatible with an IP multimedia subsystem (IMS);
converting the message between a message in the protocol format compatible with the IMS and a message in a protocol format based on an IPTV system; and
transmitting the converted message in the protocol format compatible with the IPTV system to a corresponding entity in the IPTV system according to the content of the message.

10. The method for realizing an IPTV service of claim 9, further comprising:
acquiring and saving the user service data of the user in the IMS and the IPTV system and the association relations between the user service data in the two domains, wherein the user service data comprises a user identification; and
converting the user ID of the user service data in the IMS to a user identification in the IPTV system.

11. The method for realizing an IPTV service of claim 10, further comprising:
transmitting a converted response message returned from the corresponding entity in the IPTV system in the protocol format compatible with the IMS to the user terminal.

12. The method for realizing an IPTV service of claim 10, wherein
if the message received from the user terminal is a subscription request message, the converting the message between the message in the protocol format based on the IMS and a message in a protocol format based on an IPTV system further comprises: converting the request message in the Session Initiation Protocol format compatible with the IMS to a request message in the private protocol format compatible with the IPTV system;
the transmitting the converted message in the protocol format compatible with the IPTV system to a corresponding entity in the IPTV system according to the content of the message further comprises: sending the request message in the private protocol format compatible with the IPT V system to an authentication and authorization center.

13. The method for realizing an IPTV service of claim 10, wherein
if the message received from the user terminal is a content request message, the converting the message between the message in the protocol format based on the IMS and a message in a protocol format compatible with an IPTV system further comprises: converting the request message in the Session Initiation Protocol format compatible with the IMS to a request message in the Real Time Streaming Protocol format compatible with the IPTV system;
the transmitting the converted message in the protocol format compatible with the IPTV system to a corresponding entity in the IPTV system according to the content of the message further comprises: transmitting the request message in the Real Time Streaming Protocol format compatible with the IPTV system to a content distribution and storage server.

14. The method for realizing an IPTV service of claim 13, wherein if the content request message is an on-demand request message, the converting and transmitting steps further comprise:
converting the message in the Session Initiation Protocol format based on the IMS to a message in the Hypertext Transfer Protocol (HTTP) format and a message in the Real Time Streaming Protocol format compatible with the IPTV system, sending the converted message in the HTTP format to the authentication and authorization center, and receiving an authentication response message returned from the authentication and authorization center;
sending the converted message in the Real Time Streaming Protocol format to a media center control unit for requesting an address of media server according to the address of the media center control unit in the authentication response message, and receiving the address of media server returned from the media center control unit; and
sending the request message in the Real Time Streaming Protocol format to the media server for requesting on-demand content according to the address of media server.

15. The method for realizing an IPTV service of claim 13, wherein if the content request message is a live program request message, the converting message between a message in the protocol format based on the IMS and a message in a protocol format compatible with an IPTV system, transmitting the converted message in the protocol format compatible with the IPTV system to a corresponding entity in the IPTV system according to the content of the message further comprises:
converting the message in the Session Initiation Protocol format compatible with the IMS to a message in the HTTP format compatible with the IPTV system, sending the converted message in the HTTP format to the authentication and authorization center, receiving an authentication response message returned from the authentication and authorization center;
converting the authentication response message returned from the authentication and authorization center to a message in the Session Initiation Protocol format, sending the message in the Session Initiation Protocol format to the user terminal, the message comprising a multicast address, wherein the multicast address is used by the user terminal for joining a multicast group.

16. A computer program readable medium, comprising computer program code, which, when executed by a computer unit, will cause the computer unit to perform the steps:
receiving a message sent by a user terminal in a protocol format compatible with an IP multimedia subsystem (IMS);
converting the message between a message in the protocol format compatible with the IMS and a message in a protocol format based on an IPTV system; and
transmitting the converted message in the protocol format based on the IPTV system to a corresponding entity in the IPTV system according to the content of the message.
